(19) United States
(12) Patent Application Publication
(10) Pub. No.: US 2024/0256413 A1
(43) Pub. Date: Aug. 1, 2024

(54) METHODS AND SYSTEMS RELATING TO OPERATIONAL STATUS OF A DEVICE

(71) Applicant: Dover Europe Sàrl, Vernier (CH)

(72) Inventors: Francis POURTIER, Charmes-sur-Rhône (FR); Sébastien POUZET, Saint-Fortunat-sur-Eyrieux (FR); Guillaume PONCET, Saint-Bardoux (FR); Adrien MARION, Lyon (FR); Yves LAMIRAND, Bourg-de-Péage (FR)

(21) Appl. No.: 18/564,144

(22) PCT Filed: Jun. 9, 2022
(86) PCT No.: PCT/EP2022/065772

§ 371 Date: Nov. 27, 2023

(30) Foreign Application Priority Data
Jun. 9, 2021 (WO) PCT/EP2021/065515
Jun. 9, 2021 (WO) PCT/EP2021/065517

(51) Int. Cl. G06F 11/30; G06F 11/07

(52) U.S. Cl. CPC G06F 11/3055; G06F 11/0751; G06F 11/0793; G06F 11/3013

(57) ABSTRACT

The present disclosure relates to system, computer and a computer implemented method, executed by a processing unit of the computer (210), to process at least one operation critical parameter value and/or settings for a device (110a, 110b, 110c, 1101, 1102, 1103) over a time period, for identification of an operational status of the device. The method comprises the steps of: using a first data representing at least one current critical parameter value for the device (110a, 110b, 110c, 1101, 1102, 1103) from a first data source (110a, 110b, 110c, 1101, 1102, 1103) and a second data representing at least one reference critical parameter value and/or correction value and/or setting associated with the device from a data storage (250), analysing the first data for the device (110a, 110b, 1101, 1102, 1103) and the second data with the device, whilst also optionally acquiring, aggregating and/or analysing a third data representing at least any further necessary critical parameter value associated with the device from first and/or two or more further sources (110b, 1101, 1102, 260); processing the first, second and third data with respect to the operating time of the device; and generating an action for operation of the device (110a, 110b, 110c, 1101, 1102, 1103) or an arrangement associated with the device.

### TECHNICAL FIELD

The disclosure relates to methods and systems, which with respect to one or several operational and/or configurational parameters, especially critical operational parameters, analyses and generate predictions or initiates actions regarding operational status of a device in general and an industrial printer or parts of an industrial printer, in particular.

### BACKGROUND

The printing industry is an integral part of many working units like the service industry, manufacturing industry and many other commercial aspects.

Without printed information, majority of the products are not usable or attractive for consumers, manufacturers, etc. Due to bad quality, for example, the marks may also not meet regulations in food, beverage, pharmaceutical and other. Products which are miscoded or do not comply with coding regulations might be subject to scrapping or fines.

Consequently, it is very important that printers in a production line mark products or product packaging with information related to the product with adequate quality, in a timely manner and without production delays or stops. Each printer is sophisticated comprising components crucial for correct function of the printer.

The printers may include various sensors to monitor different parts of the printer. For example, the sensors may be arranged in communication with the print head to monitor, depending on printer technology, the temperature, ink speed, ink pressure, etc. Other sensors may monitor: DC motor(s) driving various parts, such as substrate feed, print quality, air pumps, fluid pumps, fans, valves, photocells, LEDs, filament lamps, power supplies, encoders, displays, relays, laser source and many more critical parameters, such as lifetime.

Printer controllers, internal or external, may be configured to generate or receive alerts or warnings based on sensor values. In addition, user interface data and event data are generated for some printers. For example, user interface data may include print enable/print disable data, which may include the date and time a printer was enabled and then subsequently disabled by an operator, or the date and time of one or more print head cleaning operations. Other data used by some industrial printers include values for user set parameters, such as production line speed, image height and width, distance a substrate is from a print head, and actual print head temperature.

It is thus very important to detect indications of failures, malfunction, errors and preferably make predictions on the operational status of the printer before errors or failure occur and take actions before errors/failure.

### SUMMARY

According to one objective, the disclosure aims to provide a system and method, which based on various operational data stored and/or communicated from the monitored device, such as an industrial printer, or parts associated with one or several industrial printers of same or different technologies, initiates an action. The action may be one or several of automatically fixing an error or providing a user/operator information and/or remedies about possible upcoming faults or stops of the printer.

According to one aspect, at least one critical parameter, e.g., representative of printer system or printer part wear/ageing, is monitored for a monitored/analysed system and/or component during its operation. The current parameter value may be compared to values of best known and worst known systems and/or components for the same operating time, and a wearing factor may be calculated. Here, the so-called best and worst (known) values refer to values that provide boundaries for the functionality of the system and/or component. This comparison enables to “locate” the studied system and/or component between the best and the worst known components. The wearing factor can be used to calculate the forecasted operation life of the studied component or system or both, by reporting it or generating an action at system's and/or component's end of life.

According to another aspect of the described method, a critical parameter for a studied system and/or component may be monitored and its operation time and a derivative may be calculated, in order to anticipate the time when the studied system and/or component will reach its end of life. By calculating the time derivative, it may be possible to observe a behaviour change of the studied system and/or component before the critical parameter has reached the level where the system and/or component may be considered out of order.

Consequently, a user of a device or printer can be warned of a future failure of parts and consequently the device or printer before the failure really happens. This enables avoiding or reducing the production line downtime and allows to change parts only when it is really needed: thus, maintenance costs are reduced.

Aforementioned problems are solved and objectives are achieved by means of a computer implemented method executed by a processing unit of a computer, to process at least one operation critical parameter value and/or settings for a device over a time period, for identification of an operational status of the device. The method comprises the steps of: using a first data representing at least one current critical parameter value for the device from a first data source and a second data representing at least one reference critical parameter value and/or correction value and/or setting associated with the device from a data storage, analysing the first data for the device and the second data with the device, whilst also optionally acquiring, aggregating and/or analysing a third data representing at least any further necessary critical parameter value associated with the device from first and/or two or more further sources; processing the first, second and third data with respect to the operating time of the device; and generating an action for operation of the device or an arrangement associated with the device.

Additional solutions and advantages are provided by means of methods according to claims 2 to 26.

The disclosure also describes a computer comprising a processing unit, a memory and a communication interface configured to process at least one critical parameter value and/or setting for a device over a time period, and to identify an operational status of the device. The processing unit is configured to: process a first data representing at least one current critical parameter value for the device from a first data source and a second data representing at least one reference critical parameter value and/or correction value associated with the device from a data storage, analyse the first data for the device and the second data associated with the device, whilst also optionally acquiring, aggregating and/or analyse a third data representing any further necessary critical parameter value associated with the device from first and/or two or more further sources; process the first, second and/or third data with respect to the operating time of the device; and generate an action about the operation of the device or an arrangement associated with the device.

According to another aspect, a system is provided comprising: at least one printer; a database; a computer comprising: a processing unit, a memory and a communication interface configured to process a critical parameter value and/or setting for the printer or a part associated with the printer over a time period, and to identify an operational status of the printer or the part associated with the printer. The processing unit is configured to: process a first data representing at least one current critical parameter value for the printer or the part associated with the printer from a first data source and a second data representing at least one reference critical parameter value and/or correction value associated with the device from a data storage, analyse the first data for the printer or the part associated with the printer and the second data associated with the device, whilst also optionally acquiring, aggregating and/or analyse a third data representing any further necessary critical parameter values associated with the device from first and/or two or more further sources; process the first, second and third data with respect to the operating time of the device; and generate an action for operation of the printer or the part associated with the printer.

Additional solutions and advantages are provided by means of systems according to claims 31 to 33.

### BRIEF DESCRIPTION OF THE DRAWINGS

In the following reference is made to the attached drawings, wherein elements having the same reference number designation may represent like elements throughout.

FIG. 1 is a diagram of an exemplary production site comprising a number of printers, for which methods and systems described herein may be implemented;

FIG. 2 illustrates a schematic view of a system according to one embodiment;

FIG. 3a is a flow diagram illustrating a first exemplary processing steps by the system of FIG. 2;

FIG. 3b is a flow diagram illustrating a second exemplary processing steps by the system of FIG. 2;

FIG. 4 is a diagram illustrating critical operation values over a time period according to an embodiment;

FIG. 5 is a diagram illustrating critical operation values over a time period according to a first embodiment;

FIG. 6 is a diagram illustrating critical operation values over a time period according to another embodiment;

FIG. 7 is a schematic view of a filtering system monitored according to one embodiment;

FIG. 8 is a diagram illustrating critical operation values over a time period for embodiment another of FIG. 7;

FIG. 9 illustrates a schematic view of a system according to one embodiment;

FIG. 10 illustrates a schematic view of a computer system according to one embodiment; and

FIG. 11 illustrates exemplary steps of an AI-based system embodiment.

### DETAILED DESCRIPTION

Also, the following detailed description does not limit the disclosure. Instead, the scope of the invention is defined by the appended claims and equivalents.

The “cloud computing”, “cloud computer”, “cloud node” or “cloud” as the terms are used herein, are to be broadly interpreted to include an on-demand availability of computer system resources, such as data storage and computing power, without direct active management by a user and may include data centres available to many users over the Internet.

The “edge computing”, “edge computer”, “edge node” or “edge” as the terms are used herein, are to be broadly interpreted to include a distributed, normally open IT architecture that features decentralized processing power, enabling mobile computing and Internet of Things (IoT) technologies. In edge computing, data is processed by the device itself or by a local computer or server, rather than being transmitted to a data centre.

The “edge gateway” as the term is used herein, is to be broadly interpreted to include a gateway, which serves as a network entry point for devices typically talking to cloud services. Examples may include routers, routing switches, Integrated Access Devices (IADs), multiplexers, and a variety of Metropolitan Area Network (MAN) and Wide Area Network (WAN) access devices.

An “industrial printer” as the term is used herein, is to be broadly interpreted to include a heavy duty, durable and fast printer device for use in a production line. The production line may comprise one or several printer devices, such as but not limited to, Continuous Inkjet Printers (CIJ), Laser Marking Systems, Thermal Transfer Over-printers (TTO), Thermal Inkjet Printers (TIJ), as well as Case Coding Printers and Print & Apply Labelling Systems (LPA).

In an industrial printing environment, numerous printers are typically configured to simultaneously print information on various types of items. One example of an industrial printing environment may be the printing of labels on various types of packages or consumer goods. Consumer goods require a great deal of product identification (e.g., expiry dates, traceability data, etc.). The information to be printed may vary from one item to another, from one batch of similar items to another, from one site or time of manufacture to another, and/or from one type of print technology to another.

A “printer device” as the term is used herein, is to be broadly interpreted to include a device for transferring print data to an information carrier.

The term “prediction” as used herein is to be broadly interpreted to include a determination of operational status of a device and providing instruction and/or information and/or control signal to improve and/or overcome current or upcoming operational stop or failure of the device or part of the device.

The term “setting” as used herein is to be broadly interpreted to include operational parameters in general and configurations for operation and/or maintenance of a device.

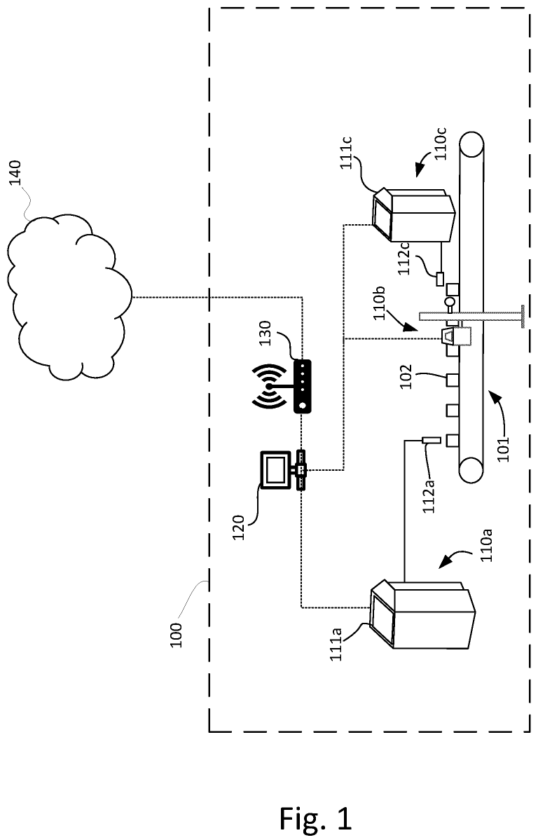

FIG. 1 illustrates a production site 100, such as a packaging site or a manufacturing location for one or several of pharmaceuticals, cables and wires, extruded plastics, flexible films, food, glass, industrial parts, metal cans and caps, beverages, etc.

In this example, the production site 100 comprises at least one production line 101 on which a number of products 102, after or during production, are marked.

A number of industrial printers 110a, 110b and 110c are arranged in the production site 100. In this exemplary embodiment, the printer 110a may be a laser printer comprising a controller part 111a and a printer head 112a; the printer 110b may be a thermal ink jet printer, and the printer 110c may be a continuous inkjet printer comprising a controller 111c and a printer head 112c. The printers may also comprise any of thermal transfer, large character high resolution piezo, valve jet, digital, etc.

The industrial printers 110a, 110b, 110c each may be connected to a monitoring computer 120 and/or an edge computing node 130. The industrial printers 110a, 110b, 110c may also be in communication with a cloud computing node 140 directly or via the edge computing node 130.

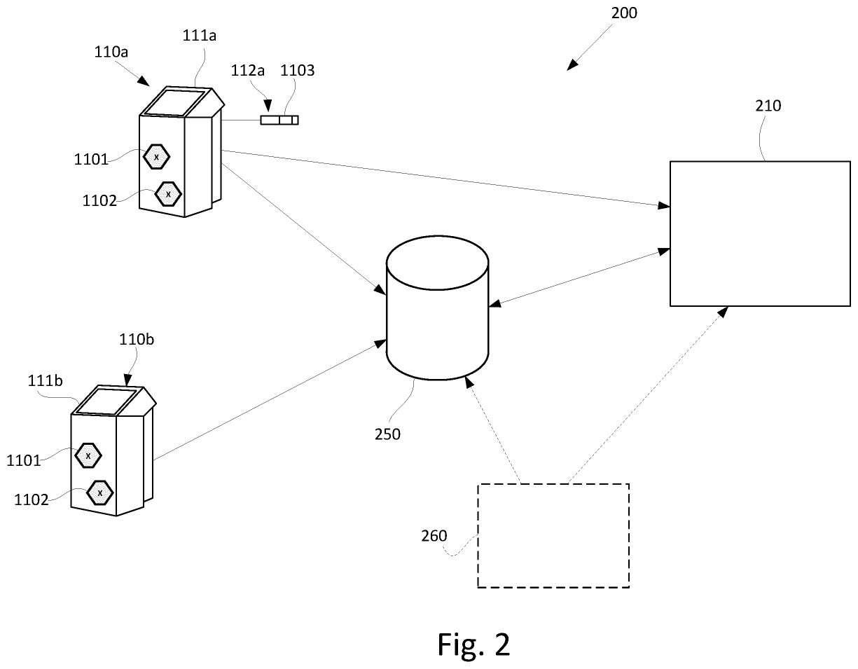

FIG. 2 illustrates a system 200 according to one exemplary embodiment.

The system 200 comprises industrial printers 110a and 110b, a computer unit 210, a data storage or database 250, and optional additional data providing unit 260.

The printers 110a and 110b each may comprise one or several sensor devices 1101, 1102 and 1103. The sensor devices may include one or several of:
Temperature sensor: for measuring temperature of one or several of the printer, printer head, ink, laser, etc.;
Pressure sensor: for measuring one or several of ink pressure, roller pressure, substrates print pressure, etc.;
Optical/magnetic encoders: for monitoring movable parts, substrate, product movement, etc.;
Level sensor: for monitoring ink level, substrates' levels, etc.;
Humidity: for measuring humidity in printed area, e.g., factory or facility around ink nozzles, etc.;
Air bubble detection: for detecting air bubbles in ink cartridge/container;
Position: for providing data about position of substrate, product, feeding and movable parts, etc.;
Distance: for providing info about distances between e.g., printer head-substrate, product, etc.;
Laser thru-beam: for detection of substrate amount/thickness,
Vision: image scanning and detection, such as barcodes, contrast, colour, print mark triggers, etc.;
Consumable: such as RFID or barcode scanner for detection of type of consumable;
Jet position sensor, slightly deviated jet sensor;
Jet presence sensor;
Jet speed sensor;
Recovery sensor/gutter overflow sensor (presence of ink in the gutter);
Head dirtiness sensor;
Phase sensor;
Covers/parts presence sensor;
Accelerometer sensor (vibrations, accelerations of the print head, print head orientation or position);
Break-off point sensor;
High voltage generator sensor (to detect and subsequently block abnormal current consumption);
Geolocation sensor;
Etc.

The disclosure is also applicable to all parts of the printer, such as actuators, motors, cartridges, belts, switches, etc.

One or several of sensors' signals may be provided directly to the printer controller 111a/111b, the database 250 or the computer 210.

The computer unit 210 may, depending on the application or requirements, such as response time, latency, etc., be part of the printer controller, computer 120, edge node 130 or cloud node 140.

The database 250, which may comprise any type of (mass) data storage, may be part of the printer memory or in communication with: the printer controller, computer 120, edge node 130 or cloud node 140.

The optional data providing unit 260 may comprise one or several external ambient sensors, such as:
Humidity: for providing humidity value in the production site or proximity of the printer;
Temperature: for providing a temperature value in the production site or proximity of the printer;
Air quality: for providing quality of air, e.g., dust or harmful particles, in the production site or proximity of the printer;
Proximity: for detecting operator(s) close to the printer;
Altitude/pressure: for measuring pressure and/or altitude of printer position;
VOC (Volatile organic compounds): for measurement of ambient concentrations of reducing gases;
CO/O2/CO2: for measurement of ambient concentrations CO/O₂/CO₂;
Etc.

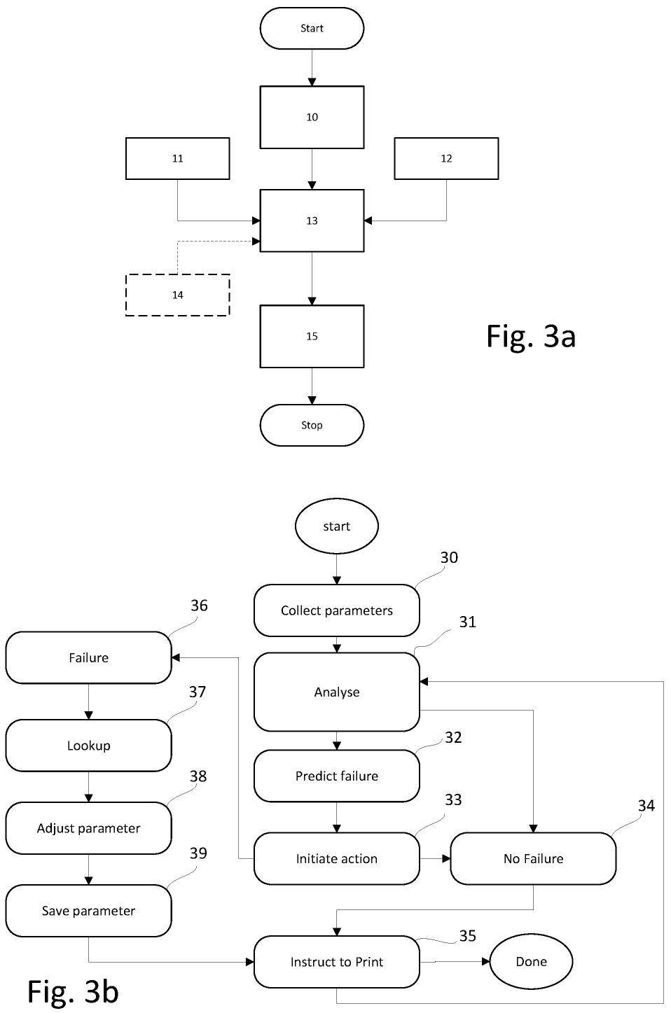

Generally, according to the exemplary embodiment of FIG. 2 in conjunction with flow diagram of FIG. 3a, the computer unit 210 receives (10) critical parameter values for the printer 110a, for example comprising printer data and/or sensor data (as exemplified previously) from sensors 1101, 1102, 1103 over a time period, for identification of an operational status of the printer. The computer unit 210 also receives (11) reference critical parameter values, correction values and/or setting parameters associated with the device from the database 250.

The processing unit of the computer 210 receives and uses (12) the current critical parameter values for the printer from the data sources and reference critical parameter values and/or correction values and analyses (13) the current critical parameter values for the printer 110a and the reference critical parameter values and/or correction values.

Optionally, the computer 210 may acquire, aggregate and/or analyse (14) further necessary critical parameter values associated with the printer from first sources and/or two or more further sources, such as additional data providing device(s) 260.

In some embodiments, the parameter (e.g., sensor) information may be tracked and stored historically for additional real-time visualization purposes. The predictive and intelligent algorithms may be used in conjunction with the parameter (e.g., sensor) information to configure an interactive dynamic real-time visualization of sensor related information and predictive insight based on the same. For example, tracked sensor level history may be utilized to prevent faults and disruptions by displaying the sensor level as it develops and for a previous period of time as a line in a (visualization) graph separated into multiple segments.

In the visualization graph, the X axis represents time and the Y axis represents a numerical value associated with the parameter. When the graph line representing a particular sensor level appears within a particular undesirable segment, the system may notify a user of a predictive fault or issue an alert.

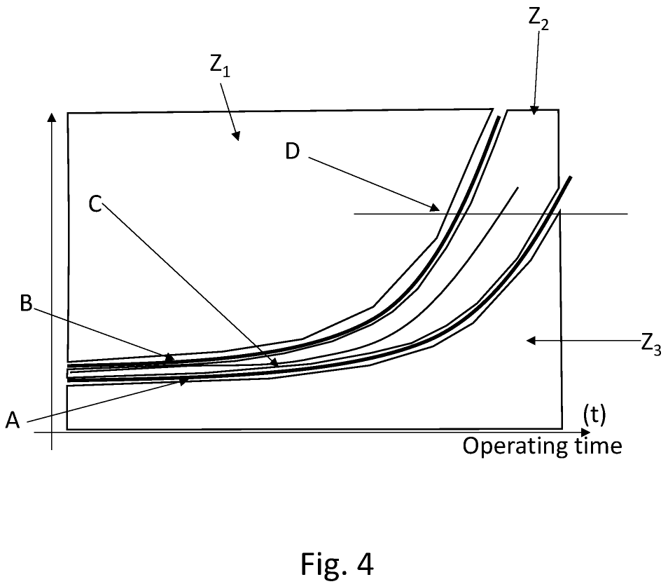

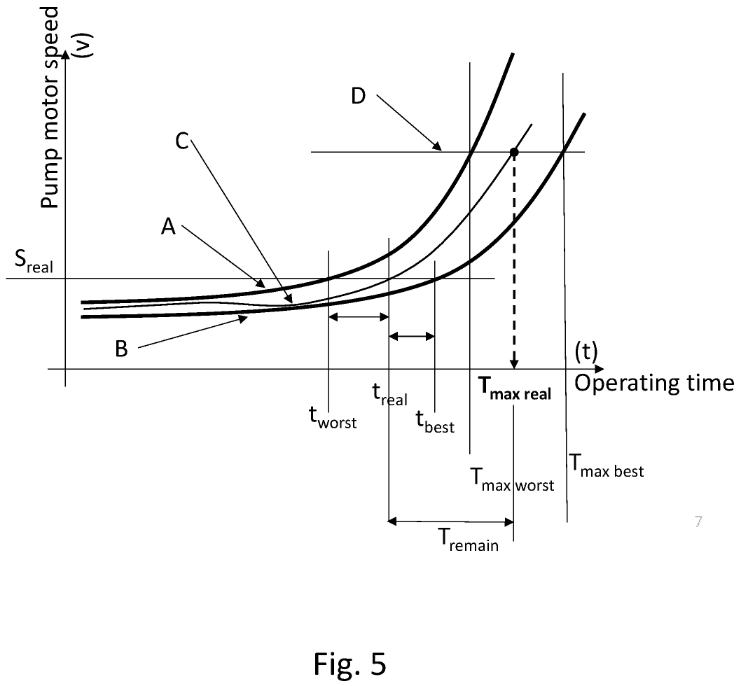

The segments may be color coded to indicate positive or negative levels. For example, the color segments may be color coded like a traffic light, green representing desirable levels, yellow representing adequate but potentially approaching problematic, and red representing problematic levels for the particular parameter. Other color schemes, for example gradient color schemes may be used. Other visual segmentation aspects may be used. In one embodiment, the visualization may be segmented similar to the graphs of FIGS. 4 and 5.

As one example, vibration levels may be displayed as a line on a graph and when the vibration levels get too high, this results in lower printer quality or other faults. In some embodiments, all data related to printing operation may be visually displayed in a graph representing performance levels of a particular area of interest. As another example, accelerator sensor history can be visualized as a level on a segmented graph that can alert the customer if the acceleration level is too high, which is not compatible with good print quality. As another example, if temperature sensor level is too high, the display will visualize that the level is getting undesirably high and visually indicate an alert and send an alert that this level may result in poor print quality, among other issues

Data exchange between computer 210, printers and/or sensors may be serially or in parallel, depending on specific applications.

The processing unit of the computer 210, processes (15) the current, reference and optionally acquired and/or aggregated critical parameter values with respect to the operating time of the printer and generates (16) an action about the operational status of the printer or an arrangement associated with the printer. The action may comprise any of generating an advice/recommendation based on associated advice list stored in a database/table, generating a prediction based on associated set of predictions stored in a database/table and/or instructions from associated instruction set stored in a database/table directly to the printer, e.g., to replace a part, stop the printer in a specific time, remaining lifetime and measurements thereof, take measures to avoid stops or delays in the production, etc. In case using an AI engine, advices, predictions and instructions may be generated based on the previously experienced machine learning, by applying machine learning to the descriptive analytics data (parameters) predicting what outcomes might be likely to occur. Thus, the machine may use its own predictions to make recommendations about what actions to take.

In the following, a number of examples are provided describing different types of critical parameters and sensor values of the printers and/or sensors, and actions provided by the computer unit 210.

FIG. 4 illustrates a schematic diagram of a first general example of monitoring critical parameters of a device, such as an industrial printer:

The diagram illustrates the critical values (Y-axis) versus operating time (X-axis).

In this example, critical parameters (P) of a device are monitored with respect to operating time (t). Curves A: represents “best part”, curve B represents worst part, curve C represents “real part” and line D a “max admissible value”. A “part” is given as a simple example and in complex configurations, several parts, entire system(s) and system critical values may be monitored.

The two curves A and B can be established during a part validation procedure and/or through field experience (e.g., gathering of Customer Usage Profiles and failure occurrences in the field) or during test runs and/or experiments, and values are stored in database 250.

These two curves, A and B, can be weighted by operating conditions (e.g., temperature, humidity, number of starts of the device, etc.). The curves can also be corrected/refined/updated by the feedback from the field (e.g., gathering of Customer Usage Profiles and failure occurrences in the field) Three zones Z₁, Z₂ and Z₃ are defined:
Z₁ where the current value is located above the “worst part” curve: an alarm/default can be set, displayed and/or transmitted;
Z₂ where the current value part is located between the “worst part” and the “best part” curve. A remaining operating time can be estimated, displayed and/or transmitted; and
Z₃ where the current value is located below the “best part” curve: an alarm/default can be set, displayed and/or transmitted.

Depending on the monitored parameter, curves A and B can be flipped over.

The actions may also comprise transmitting control signals to the printer, e.g., for reconfiguration, stop, changing speed, etc.

In one embodiment, the computer unit 210, receives the current P-values (curve C) and processes data with respect to the stored values in the database 250. Based on the comparison one or several actions, as mentioned above, may be executed.

In another embodiment, the computer unit 210, may comprise an Artificial Intelligence (AI) portion that processes the data. Generally, the process cross-checks or vets the retrieved critical parameter values in order to verify particulars of the printer and the cross-checked or vetted critical parameter values are used for the action about the operational status of the printer. More particularly, the machine learning process may comprise:
1. Training the model: the model is trained using critical parameter values or settings with respect to the operational lifetime of the printer/printer part:
   a. parameter data and operational lifetime;
2. Predict with the trained model:
   a. Input to the model: parameter data;
   a. Output of the model: operational lifetime prediction and optionally may generate parameter adjustments.

A machine learning process using, for example, a supervised regression model may be used. The model can be improved with reliability data collected from the printer during runtime and in edge and cloud solutions with data from other printers.

The method described herein may also use unsupervised learning models, which work on their own to discover the inherent structure of unlabelled parameters from the printer. For example, the unsupervised learning model can identify that a specific fault often depends on functionality of a specific part of the printer. However, an additional data analysing may be needed to validate that may be needed.

The use of supervised or unsupervised learning may depend on the objectives. While in supervised learning, the goal is to predict outcomes for new data, with an unsupervised learning the objective may be to get insights from large volumes of new data.

The unsupervised learning may be applied for anomaly detection, recommendation engines, customer personas and imaging.

It is also possible to use a semi-supervised learning approach, which implies using both labelled and unlabeled data.

FIG. 3b. illustrates exemplary steps of an AI-based system embodiment executed by the processing unit of the computer, e.g., the computer 210.

During a printing process, critical parameters are acquired in step 30 and analysed in step 31. Based on the trained model, failure may be predicted in step 32 and an action initiated in step 33. If no failure is predicted 34 or an action is initiated, printing is carried out in step 35. Parameters of successful printing are forwarded to analyse step 31. If initiated action at step 33 still encounters a problem, the failure is analysed in step 36 and looked up 37 in a parameter database or learning results of, e.g., a neural network or previous machine learning. New suggestions for adjusting parameters may be generated in step 38 and saved 39 and forwarded to printer. Successful parameters may be forwarded from printer to the analyse step 33. In this example, parameters may also include settings and configuration parameters. The analyse step 31 may comprise a machine learning engine (AI engine), which continuously receives parameters for successful prints and failed prints, and automatically learns and improves from experienced parameters to generate predictions and advices for operation of the printer.

In some embodiments, after the critical parameters are acquired, the system checks that the parameters meet nominal values and if out of bounds may stop printing or alert the user to stop printing. Critical parameters include, but are not limited to, jet speed parameter (could be too fast or too low or too much variable), ink level (too low), or voltage current consumption (too high). High voltage generator current consumption is a security parameter because it could be dangerous for end user when consumption is too high.

For example, a pump or filter replacement part may be provisioned with the technician in the case of a predictive failure determination related to printer working point parameters being out of bounds or related to a filter kit replacement determination. As another example, a droplet generator replacement part may be provisioned with the technician in the case of a predictive failure determination related to the printer jet being not well positioned or related to printer autocalibration being out of range.

When there is a trend of a particular parameter evolution, the system 200 can apply predictive algorithms to anticipate a failure in a particular time frame. The system 200 can apply predictive algorithms to anticipate a failure in a particular time frame by detecting a specific trend of a particular parameter evolution. The system 200 can identify the potential failure before it occurs and initiate corrective action to address the potential failure. Corrective action includes alerting the end user, alerting the helpdesk to call the customer, planning, scheduling or provisioning a visit to the customer by a technician. In some embodiments, the visiting technician can be dispatched with a replacement part such as a pump, filter, droplet generator or filter kit replacement.

The diagram of FIG. 5 is yet another exemplary embodiment, which illustrates critical values over a time period in an exemplary case, in which a pump speed is monitored. X-axis represents operation time (t) and Y-axis represents pump motor speed (V) to keep a (pressure, flow) operating point. D is max admissible pump motor speed.

The computer 210 processes the current data and data from the database 250 and for a current tᵣₑₐₗ operating time:
1) Measures the current Speed Sᵣₑₐₗ
2) Looks for corresponding t_{best} and t_{worst}
3) Calculates:

### Ageing Factor:

A_{f}=(tᵣₑₐₗ−t_{worst})/(t_{best}−t_{worst})

### And

### Estimated Real Pump Durability:

T_{max real}=T_{max worst}+A_{f}*(T_{max best}−T_{max worst})

### And

### Remaining Operating Time:

Tᵣₑₘₐᵢₙ=T_{max real}−tᵣₑₐₗ

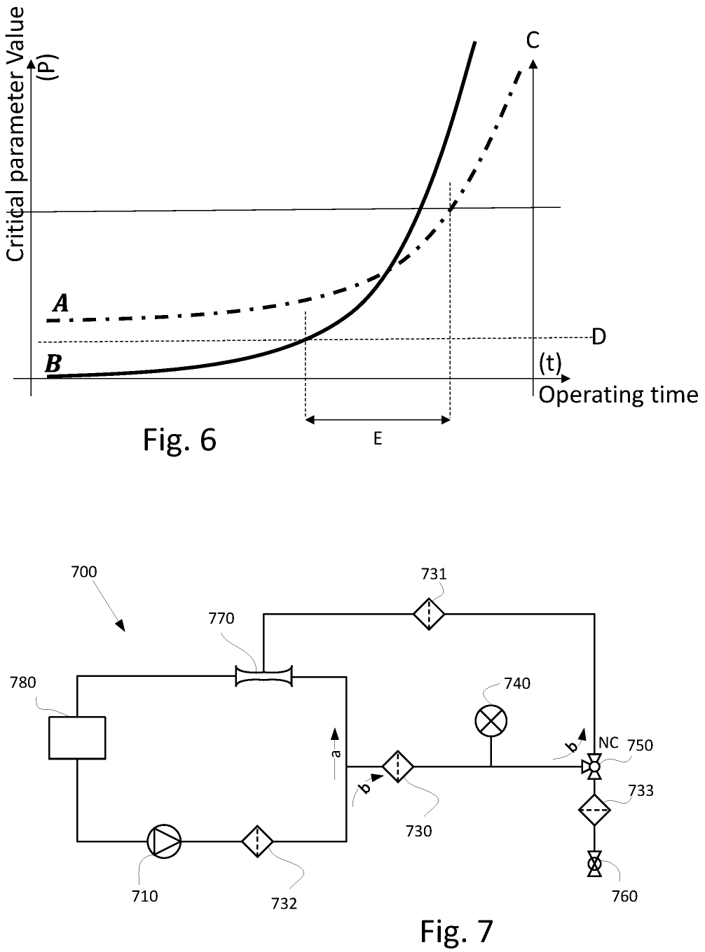

According to a second aspect of the described system, the computer unit may monitor parameter derivative over a time period. This is illustrated schematically in FIG. 6. In the diagram, Y-axis represents critical parameter value (P) for a specific operating point and X-axis operating time (t).

In the diagram, curve A represents ΔP and curve B represents ΔP′, C represents derivative of the critical parameter for a specific operating point, D represents chosen derivative threshold and E time interval between alarm setting and part failure.

At regular intervals, the value of a critical parameter is measured and provided to computer unit 210, which:
Calculates a time derivative ΔP′ of a critical parameter, and
If ΔP′ exceeds a chosen threshold, initiate an action.

The usage of ΔP′ enables to initiate an action before the monitored part is faulty, and so enables to replace the part before the part failure. This allows to avoid printer failure and production line downtime.

In one embodiment, pressure through filters may be monitored:
At regular intervals, the pressure drop ΔP through the filter is measured, and the values are provided to computer unit 210,
The time derivative ΔP′ of the pressure drop is calculated by the computer unit 210, and
If ΔP′ exceeds a chosen threshold (e.g., maximum critical parameter value), an action, such as an alarm, is initiated.

Thus, the usage of ΔP′ enables to execute an action before the filter is really clogged, and so to avoid filter failure, printer failure and production line downtime.

Although the graphs of FIGS. 4-6 are illustrated in two dimensions, by adding additional parameters it is possible to obtain three or multidimensional graphs, which can be used to consider additional parameters when analysing the current and stored critical parameters. Additional parameters for obtaining multidimensional graphs may for example include temperature and/or number of starts of the printer.

Another embodiment for detection of main ink filter clogging, for example in a Continuous Inkjet (CIJ) is illustrated schematically in FIG. 7. In this example, a circuit 700 in which an ink pump 710 and the related driving units are illustrated in a very schematic manner.

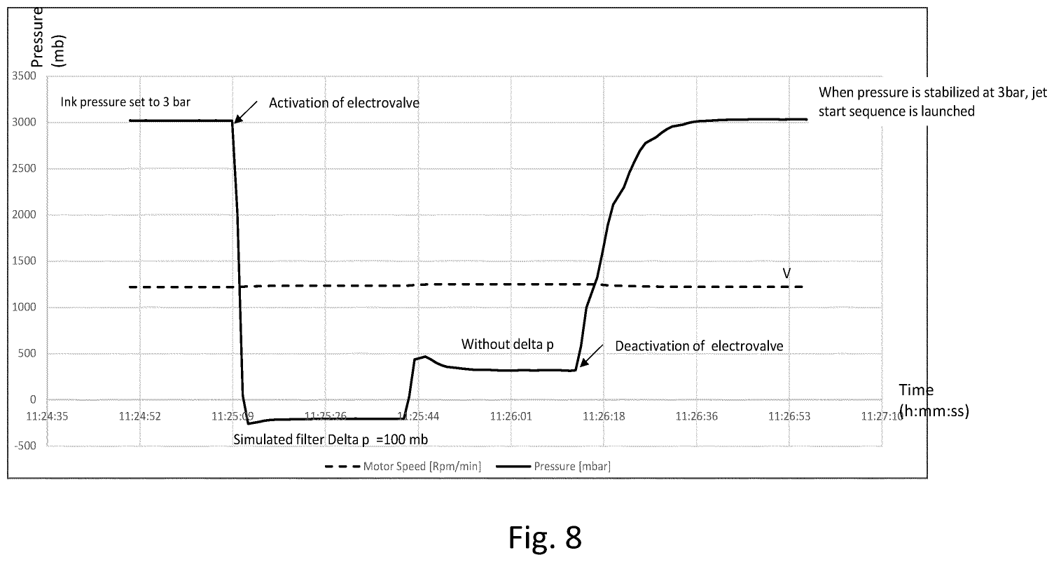

Diagram of FIG. 8, illustrates measurement examples for simulated effect of the clogging resulting in 100 mbar pressure difference over a time period (e.g., approx. 3 mins).

The circuit 700 may further comprise main ink filter 730, ink pressure sensor 740, electrovalve/electromagnetic valve 750, ink pressure valve 760, vacuum resistor 770, ink reservoir 780, and additional filters 731, 732 and 733.

In a first step (FIG. 7 in conjunction with FIG. 8) a base operating point is set:
The electrovalve 750 is in its normal position (not activated),
Ink pressure valve 760 is closed.

Consequently, ink flows only through the vacuum restrictor 770, i.e., arrow a.
The ink pump 710 is controlled by a controller (not shown) in order to set the ink pressure, which is measured by the ink pressure sensor 740, e.g., to 3 bar,
The pump 710 motor speed (V) to keep 3 bar ink pressure, is stored.

In a second step, a second operating point is set:
The pump motor speed (V) is kept at the same level,
Electrovalve 750 is activated,

Consequently, the ink flows through the vacuum restrictor 770 and through the main ink filter 730, i.e., arrows b. As the pump 710 speed is maintained and there is less pressure drop downstream of the pump, the ink pressure decreases depending on the main filter's pressure drop.

The critical parameters from pressure sensor 740 (and/or additional sensors, not shown) are sent to a computer (as described earlier) for pressure data analysis:
As the vacuum restrictor 770, in this example is a venturi tube, an aspiration is applied downstream of the main ink filter 730.
If the ink main filter 730 is clogged, the pressure read by the ink pressure sensor 740 (current value) will directly be the aspiration due to the venturi.
If the ink main filter 730 is not clogged, the pressure read by the ink pressure sensor 740 will be higher.

The disclosed method allows predicting clogging in the additional filters 731, 732 and 733 based on the opened and closed circuits due to operation of valve 750 (i.e., flow along arrows a and b) and measured values from the pressure sensor 740. For example, based on the pressure values obtained when the valve 750 is open and close, and consequently there is a flow through each filter 730, 731, 732 and 733 for different operational state of the valve 750, it may be possible to predict clogging of the filters as pressure values for different stages of clogging of main ink filter 730 will be registered and associated with different flows through the filters.

It may be possible to choose adapted threshold values, either, e.g., to alert the user/operator about a future clogging other ink main filter 730, or to detect a completely clogged filter. In some exemplary embodiments, the filter may be cleaned or changed automatically.

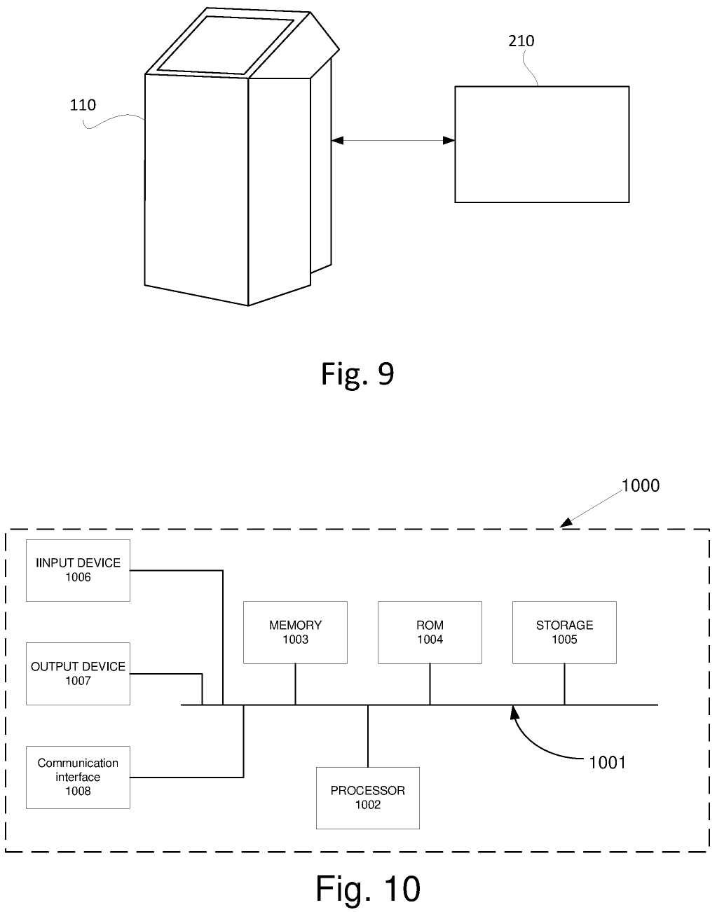

In some embodiments, alerts may be provided to the user, the operator or a helpdesk associated with the system 200. Alerts may be provided as SMS, email, web browser notification, dashboard notification, smartphone app notification or the like. In some embodiments, dashboards displaying printer status and alerts may be utilized on the user or operator desktop, tablet, mobile/smart phone or production floor monitor. FIG. 9 illustrates another example of a system comprising a printer unit 110 and a computer 210, in which the teachings of the disclosure are implemented. Following examples may refer to this system or previous systems when described.

In the subsequent examples, following generalized parameters will be used in the pseudo-codes realizing the methods executed by the processing unit of the computer unit 210.
Printer ID (PID): Identity of the printer, e.g., serial number;
Printer Running Data (PRD): Data logfile containing printer operation data;
Printer operational (PO): a value or indication that determines the printer is in operational state;
Fault code (FC): a code indicating fault type in a Fault List Column of, e.g., a logfile;
Counter n: a counter for specific monitored function/device, wherein n is an integer;
Tabm[i,j]: table for storing data, such as time data;
T: monitoring period;
Lookup Table(LUT): Lookup Table containing printer and/or ink data;
TabR: Printer running data table;

In a first exemplary case, the printer 110 is monitored for detection of stops without using printer automatic shutdown.

The computer unit 210 receives from the printer 110 its identity and printer running data. In the following pseudo-codes, some code parts may be defined or commented in curly brackets “{ }”.

Look for a fault code, e.g., “Shutdown not done properly (appears at next printer start-up)”

```
In the PID PRD, look for FC
  FC =0;
  i=0;
  Counter n=0;
  Create a “Table n [i.j]”;
  For each fault code during last T;
    Look for last time when PO {(this time is stored in Tabm[i,0])}
    Look for next time when PO {this time is storedTabm[i,1]}
    Tabm[i,2] = Tabm[i,1] − Tabm[i,0];
    {calculate duration of shutdown}
    If Tabm[i,2] > x hours
      Counter n=Counter n + 1;
      If Counter n >= 3;
        Generate an action (e.g., send notification to user);
        List of last “Counter n” bad shutdown [start-end];
        {display Tabm}
    i=i+1
```

In this case, the user notification or action may for example be information about the shutdowns “during period [start-end], printer (PID) was shutdown not properly and could lead to unexpected downtime”;

In a second example, the running duration depending on ink may be monitored:

The process may, for example, be executed once a week:

The computer 210 receives PID, PRD and looks for PO

```
Counter n=0;
i=0;
TabR [i,j]=create TabR;
  For each PO during last T;Look for last
  time when PO; {this time may be
stored in TabR [i,0]}
  Look for next time when PO; {this time may be stored in TabR[i,1]}
  TabR[i,2] = TabR[i,1] − TabR [i,0]; {calculate running duration}
  If TabR[i,2] > maxDuration(LUT);
    Counter n=Counter n+1
    If counter n >=3
      Initiate an action (e.g., send notification to user)
      List of last N periods [start-end] {display or provide TabR}
  i=i+1
```

The user notification may comprise: “During period [start-end], printer (PID) was running continuously without print head cleaning as per recommended and could lead to unexpected downtime.” Another outcome may also be to send by computer 210 a control signal to the printer or printer head, to clean printer head or shut down in controlled manner.

In one embodiment, the shutdown duration without power supply may be monitored:

After each data collection, the following may be launched:

```
{StopWOPS= Stop without power supply}
In PID PRD, look for ‘Time’ column;
  For each line
    Calculate StopWOPS = date time [N] − date time [N-1];
      If StopWOPS > max duration stop wo power supply (LUT); If
    printerReset=0
      {printer was not Reset/flushed/drained as recommended}
        Generate an action;
```

The action may be a user notification: e.g., “During period [start-end], printer (PID) was shutdown wo power supply more than 2 weeks without flushing as per recommended and could lead to unexpected downtime.”

In one embodiment the working temperature of the printer/ink may be monitored and provided to computer 210.

```
{TempInk= Ink temperature value}
Input: PID, PRD + LUT
  C= constant; {e.g., 1≤C≤5}
  counterTemp1=0;
  counterTemp2=0;
  i=0;
  TabT [I,j] =create TabT;
  In PID PRD look for ‘TempInk column’; For each TempInk > C*(max operating
temp (LUT)) during last T
    Store time in tabTemp[i,0];
    Look for TempInk < C*max operating temp (LUT);
    {store time in tabTemp[i,1]}
    tabTemp[i,2] = tabTemp[i,1] − tabTemp[i,0]
    {calculate duration of over Temperature}
    If tabTemp[i,2] > x h {if x hours has passed}
      counterTemp1=counterTemp1+ 1
      If counterTemp1 >= 1
        Generate an action;
      Else if tabTemp[i,2]> y h; {if y hours has passed}
        counterTemp2=counterTemp2+ 1;
        If counterTemp2 >=5
        Generate an action;
        List of last periods/duration [start-end] {display tabTemp}
    i=i+1
```

The action may for example be a service desk notification: “During period [start-end], printer (PID) was operating at temperature >XX° C. as per recommended. Please consider other ink reference or modify printer environment.” In some example embodiments, the computer may control environmental parameters, such as temperature, air filtration, light, etc. to remedy the problems.

In one exemplary embodiment, the printer may be on, without printing assignments during which solvents may still be consumed. By eliminating this solvent consumption can be reduced.

The method may be executed periodically:

```
Input: PID and PRD
  In PID PRD, look for ‘PO’, ‘PrintingState’
  and ‘AdditiveCounter’ columns;
  SC=0; {Solvent consumption}
  SC_tot=0; {Total solvent consumption}
  cn: {constant solvent consumption volume}
  If PO
    If PrintingState=0 during at least T [t1-t0]
      SC= additive counter[t1]-additive counter [t0];
      SC_tot= SC_tot+SC;
      If SC_tot > x cn during last T
        Initiate an action;
```

The action may be a “user notification”: E.g., “During period [start-end], printer was running without printing and lead to additive over consumption of SC ml.” or a control signal for controlled shut down of the printer.

In one embodiment working point critical values such as Pressure, Motor Speed, Viscosity, Temperature, operational point limit for reaching out of bounds may be monitored. The sensor data is received from the printer 110 or corresponding sensors to computer 210.

```
Input: PID PRD + LUT
The method may be launched once a day:
In PID, PRD look for:
      PID1 & PID2 in Production Settings file:
      I1, I2, and I3
      {eg., I1=head type, I2=ink circuit type and I3= umbilical length}
      In PID1 file look for:
      ‘PO, ‘P1’, ‘P2’, ‘P3’, ‘P4’, ‘P5’
  {Eg. P1 =pressure, P2=motor Speed, P3= viscosity, P4= Viscosity Set Point, P5=Ink
  temperature, P6= Reference Pressure, P7= nominal pressure; P8= Nominal motor
  Speed}
      PID2 file look for:
      ‘PO’, ‘P5, ‘P1’, ‘P6’ columns for PID2;
      If(printer=PID1)
        If PO true
          If c2*P4<P3<c3*P4
            If P1<c4*P7(calculated from LUT, ink and temperature data or
              P1>c6*P7 (ink,Temp)/
            Initiate action;
            Else
              If P2<c7*P8 (calculated from LUT, pressure and printer data) or
                P2>c8*P8 (pressure,printer)
              Initiate action;
    If(printer=PID2)
        If PO true
            If P6-c9<P1<P6+c9
                If P1<c4*P7 (calculated from LUT and temperature data ou
                  pressure>c6*P7 (ink, Temp)/c5
                    Initiate action;
                  Else
                      If P2<c4*P8 (calculated from LUT, pressure and
                        printer data) or P2>c6*P8 (pressure,printer)
                      Initiate action;
```

Example of constants may be:

C2 and C3 is tolerance around viscosity (+/−10%) to say that viscosity is OK. Could be modified, 5% or 20%;

C4 and C6 is margin and Vs nominal pressure (+/−15%) may be accepted. This will define specificity and sensitivity of algorithms (see ROC curves theory);

C7 and C8 is margin and Vs nominal motorSpeed (+/−25%) may be accepted. Will define specificity and sensitivity of algorithms (see ROC curves theory)

C9 is absolute value around Reference Pressure. This value could be changed;

Some exemplary values for constants may thus be: C2: 0.9; C3: 1.1; C4: 0.85; C5: 1000; C6: 1.15; C7: 0.75; C8: 1.25; C9: 70;

The action may for example comprise “Service desk notification/recommendation”: such as “List root causes failures on pressure line linked to the helpdesk tool” or control signals to printer to adjust functional parameters.

In one embodiment ink jet deviation measurements are monitored.

```
Reminder: x fault = jet not well positioned
In PID PRD, look for x fault in ‘Fault List’ column;
CounterX=0;
TabX=createTab;
For each non-consecutive x fault during last T
CounterX=CounterX+1;
  If CounterX >= x1 {1≤x1≤20}
    Initiate action;
```

The action may comprise a service desk notification/recommendation or sending control signal to clean head, start-stop procedure, replace modulation assembly.

In another embodiment breakoff point procedures of the printer may be monitored. Breakoff points procedures (BOP) are registered by the printer 110 and forwarded to computer 210.

```
Inspect PID PRD
counterBOP=0; {Counter for BOP}
For each breakoff point procedure in period T
  counterBOP=counterBOP+1;
  If counterBOP>= Predetermined value
    Initiate action;
```

An action may be a service desk notification/recommendation, such as “Analyse piezo table and advise customer accordingly” or “Try to understand why customer launches BOP so regularly” or “Confirm that the customer checks the cleanliness of the printer before to launch BOP” or a signal to printer to initiate, e.g., checking for cleanness.

In another embodiment solvent consumption of the printer 110 may be monitored for determination of out of standard bounds:

```
{Exemplary parameters may comprise: P1: Ink Temp offset, P2= Pressure Kit Installed
(an airflow for avoiding dust entering the printhead), P3= Umbilical Length, tP4= IC
Contrast, P5= Solvent Consumption Printer, P6= solvent consumption, P7= solvent
consumption std, P8= Printer Solvent Consumption}
Input: PID, PRD + LUT
Remove lines with PO;
Calculate T_mean=mean(P1(LUT,printer));
Extract from ProductionSettings.cfg values of:
  <P2>, <P3>(0=x1m, 1=x2m), <P4> (true=PD2, false=PD1) {1≤x1≤5; 5≤x2≤10}
P5 = AdditiveCounter(T_{end})-AdditiveCounter(T0)/(T_{end}-T0)
From LUT, calculate P7(T_mean, PrinterType) with ABC coeff for PD1 or PD2
  PD1 case:
    <P3>0 && <P2> false
      P6= P7
    <P3>1 && <P2> false
      P6= c1*sP7 {e.g. c1= 1.12}
    <P3>0 && <P2> true
      P6= c2*P7 { e.g., c2= 1.25}
    <P3>1 && <P2> true
      P6= c1*c2*P7
  PD2 case
    <P2> false
      P6= P7
    <P2> true
      P6= c2*P7
  If P8 > c2*P6
    Initiate action;
```

The action may be sending notification to helpdesk for technician intervention.

Overconsumption may be probably due to Peltier cell or air leakage.

In one exemplary embodiment, the solvent consumption out of standard bounds may be monitored:

Remove lines with PO;
Calculate T_mean=mean(TempInk-offset(LUT,printer));
Extract from ProductionSettings.cfg values of:
<PressureKitInstalled>, <OmbilicLength>(0=x1m, 1=x2m), <ICContrast>
(true=PD2, false=PD1) {1≤x1≤5; 5≤x2≤10}
SolventConsumptionPrinter = AdditiveCounter(Tend)-AdditiveCounter(T0)/(Tend-
T0)

For example, the result of this computation will be:

T_{end}-T₀=7 days and 37” that can be converted into 168h
AdditiveCounter(T_{end})-AdditiveCounter(T₀)= 987cc (for example)
SolventConsumptionPrinter=987/168-5,875cc/h

The action may be service desk notification/recommendation: “Overconsumption probably due to: Peltier cell or Air leakage”. The action may also be stopping the printer in a controlled manner.

The disclosure also describes intelligence advices. In one embodiment expiration date of ink may be monitored:

```
Data access: PID_PRD +_Consumable History;
In PID Consumable History logfile, look for ‘Expiration Date’ and ‘ProductionDate’ columns
of latest value in column ‘End date’;
  Ink lifetime = ExpirationDate − ProductionDate;
  Additive lifetime = ExpirationDate − ProductionDate
For ink only reference starting with !A);
  In PID PRD, look for ‘InkLevel column {tank ink level}
  If InkLevel> x1% && current date > expiration date + x2% ink lifetime
    Initiate action; {e.g. x1= 30; x2 = 25}
For additive (reference starting with A)
  If current date > expiration date + x2% ink lifetime
    Initiate action;
```

The action may comprise notification to a user or delivering of consumables (ink) to the user. Customer notification may comprise “Printer (PID) is using ink whose date is expired by more than ‘25% lifetime’. Please replace ink”.

In one embodiment, phase measurement's deviation along time may be monitored.

```
Data access: PID PRD
Nb_phase_initial=Nb_phase_OK or Nb_phase_initial=Nb_phase_OK (ink dependent);
  If Nb_phase_OK<Nbphase_initial-2
    Initiate action;
```

The action may comprise service desk notification/recommendation, checking for fault cases (e.g., with a helpdesk tool) maintenance procedure, ordering new parts, ordering service, instructions to call costumer, provide information for correction, or take other automated actions such as correcting settings, ordering service, In yet another embodiment, number of printer auto diagnostics may be monitored.

```
Data access: PID PRD
Counter=0
If autodiagnostic launched
  Counter + 1
  If counter > x during y time
    Initiate action;
```

The action may comprise sending notification to a service/help desk notification or recommendation and checking helpdesk tool that includes potential fault causes.

FIG. 10 is a diagram of an exemplary computer 1000, used in systems described herein.

The computer 1000 may include a bus 1001, one or more processors 1002, a memory 1003, a read only memory (ROM) 1004, a storage device 1005, an input device 1006, an output device 1007, and a communication interface 1008. Bus 1001 permits communication among the components of the computer 1000. The computer 1000 may also include one or more power supplies (not shown). One skilled in the art would recognize that computer 1000 may be configured in a number of other ways and may include other or different elements.

The processor 1002 may include any type of processor or microprocessor that interprets and executes instructions. The processor is configured by programming instructions on non-transient computer readable media, such as the memory 1003 which may include a random-access memory (RAM) or another dynamic storage device that stores information and instructions for execution by processor 1002. Memory 1003 may also be used to store temporary variables or other intermediate information during execution of instructions by processor 1002.

ROM 1004 may include a conventional ROM device and/or another static storage device that stores static information and instructions for processor 1002. Storage device 1005 may include any magnetic, optical or solid-state disk and its corresponding drive for storing information and instructions. The storage device 1005 may also include a flash memory (e.g., an electrically erasable programmable read only memory (EEPROM)) device for storing information and instructions.

The input device 1006 may include one or more conventional mechanisms that permit a user to input information to the computer 1000, such as a keyboard, a keypad, a directional pad, a mouse, a pen, voice recognition, a touchscreen and/or biometric mechanisms, etc. Output device 1007 may include one or more conventional mechanisms that output information to the user, including a display, a printer, one or more speakers, etc. Communication interface 1008 may include any transceiver-like mechanism that enables computer 1000 to communicate with other devices and/or systems. For example, communication interface 1008 may include a modem or an Ethernet interface to a LAN. Alternatively, or additionally, communication interface 1008 may include other mechanisms for communicating via a network, such as a wireless network. For example, communication interface may include a radio frequency (RF) transmitter and receiver and one or more antennas for transmitting and receiving RF data. The communication interface may be configured to communicate with printer devices, vision system and the cloud computing interface.

The computer 1000 provides a platform through which relevant data is sent and received from the connected devices, e.g., through a network. The relevant data including diagnostic data, instructions and information. The computer 1000 may also display information associated with the connected devices to a user of computer 1000 in a graphical format. According to an exemplary implementation, computer 1000 may perform various processes in response to processor 1002 executing sequences of instructions contained in memory 1003. Such instructions may be read into memory 1003 from another computer-readable medium, such as storage device 1005, or from a separate device via communication interface 1008. It should be understood that a computer-readable medium may include one or more memory devices or carrier waves. Execution of the sequences of instructions contained in memory 1003 causes processor 1002 to perform the acts that have been described earlier. In alternative embodiments, hard-wired circuitry may be used in place of or in combination with software instructions to implement aspects consistent with the methods described. Thus, the disclosure is not limited to any specific combination of hardware circuitry and software.

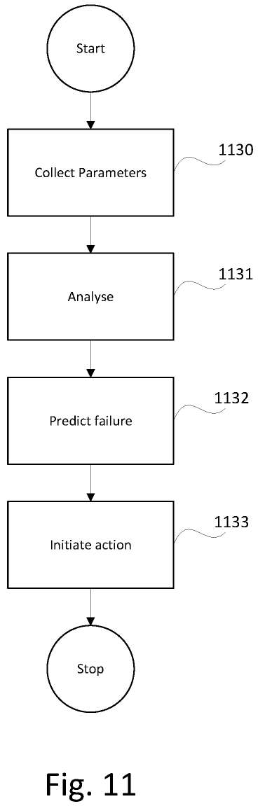

FIG. 11 illustrates exemplary steps of an AI-based system embodiment executed by the processing unit of the computer, e.g., the computer 210 (FIG. 2). During a printer's lifetime, critical parameters are acquired in step 1130 and analysed in step 1131. Based on the trained model, failure may be predicted in step 1132 and an action initiated in step 1133. For example, in the case of a printer generating an alert related to the jet (printhead) being not well positioned, step 1131 may include determining by the printer that an alert has occurred, and either pushing the alert out to system 200 and/or storing the alert in a log file. The log file is used in the case where the printer is waiting for the system 200 to poll the printer for heartbeat data. In some embodiments, the printer stores a day, a week, a month or more of sensor data or operational data in log files on a regular basis that could be each second, each minute, each hour or each day or something else. The log file data is used to determine service issues, including intelligent advice and predictive failures.

In some embodiments, the gateway polls printer status in real time or near real time (latencies of μ seconds to some seconds), or every minute, or another predetermined or preconfigured period of time. In some embodiments, the printer or printer platform may publish an alert or a fault to the gateway. In some embodiments, the printer platform can utilize a TCP/IP protocol to talk to printers. When the printer platform detects a warning or a fault, the platform publishes (real-time framework signal R used for chatting) to a module in the gateway that sends the published message to the gateway, the gateway may process and analyze and send a copy to the cloud, where the message is stored and also sent to a notification service. In some embodiments, the communication protocol between the gateway and the cloud includes AMQP over SSL or the like.

The printer platform identifies that printer has an alert (fault or warning). There may be two types of alerts, warning and fault, and both types are sent from the printer platform to the gateway.

For every alert received, the printer platform processes the alert, cleanses it, and sends it to the gateway, the gateway sends to the cloud for storage in, e.g., JavaScript Object Notation (JSON) format (or any suitable format), and also the notification is sent to a notification service module in the service fabric. If the customer subscribes to notifications, then a communication notification is communicated to the customer, via email, SMS, phone call, voice status or the like. In some embodiments part of alerts received are sent to platform, e.g., depending on customer subscription (e.g., only following one specific module) or printer configuration

The predictive module (in the gateway) receives the alert message and searches for appropriate algorithms to apply for the particular alert message. In some embodiments, the algorithms are stored in a lookup table of algorithms and associated to alerts.

To summarize, predictive algorithms can use:
Collection of warnings and or alerts during particular time frame can traduce potential long downtime in near future
Collection of sensor parameter during particular time frame can traduce potential long downtime in near future

In some embodiments, for a predetermined set of alerts, the printer platform also provides the message to a diagnosis module (in the gateway), to apply the diagnoses algorithm.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the methods and systems may be implemented at least in part by means of both hardware and software, and that several “means”, “units” or “devices” may be represented by the same item of hardware.

The above-mentioned and described embodiments are only given as examples and should not be limiting to the disclosure. Other solutions, uses, objectives, and functions within the scope of the disclosure as claimed in the below described patent claims should be apparent for the person skilled in the art.

The various embodiments of the disclosed methods and systems described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Solid State Disc (SSD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the disclosed methods and systems can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments have been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize methods and systems in various embodiments and with various modifications as are suited to the particular use contemplated. The features of the embodiments described herein may be combined in all possible combinations of methods, apparatus, modules, systems, and computer program products.

1. A computer implemented method, executed by a processing unit of a computer, to process at least one operation critical parameter value and/or settings for a device over a time period, and identify an operational status of the device, the method comprising:
monitoring a first data during the operation of the device, the first data representing at least one current critical parameter value for the device from a first data source and a second data representing worst and best values representing boundaries for the functionality of the device;
analysing the first data and the second data, by comparing the first and second data; and
generating an action for operation of the device or an arrangement associated with the device based on the result of the comparison.

2. The method of claim 1, wherein said processing is an artificial intelligence or machine learning process to cross-check or vet the retrieved the first data in order to verify particulars of the device and wherein the cross-checked or vetted first data are used for the action about the operation of the device.

3. The method of claim 1, wherein said processing is an artificial intelligence or machine learning process comprising the steps of:
training a model using the first data with respect to an operational lifetime of the device,
predicting with the trained model, by input to the model parameter data, and
generating the action.

4. The method of claim 1, wherein said processing comprises:
generating a first and a second boundary values based on the second data, wherein the values in between the first and the second boundary values constitute a normal operational state for the device, and
monitoring the first data and generating the action.

5. The method of claim 1, wherein the device comprises or several of:
a printer,
an industrial printer,
a part associated with the printer/industrial printer, or
a sensor.

6. The method of claim 1, wherein the second data is stored in a data storage pre run of the device.

7. The method of claim 1, comprising receiving further data representing parameter values from one or several additional sensors or data collecting devices.

8. The method of claim 1, comprising forwarding to the data storage, continuously running data representing critical parameter values and/or in an initial phase.

9. The method of claim 1, further comprising providing at least one unique identifier, identifying the device.

10. The method according to claim 4, comprising building a plurality of numerical zones representing first data out of bounds and within bounds.

11. The method according to claim 10, wherein out of bounds zones comprise values for nonacceptable and critical parameter values.

12. The method according to claim 4, wherein the first and the second boundary values are generated during one or several of device validations, through field experience, or test-runs.

13. The method according to claim 12, wherein the first and the second boundary values are weighted by operating conditions, comprising one or several of temperature, humidity, pressure, number of starts of device, or a parameter contributing to aging of the device.

14. The method of claim 12, wherein the first and the second boundary values are collected and/or corrected and/or refined via feedback from the device, a user, usage profiles and/or failure occurrences in the field.

15. The method of claim 4, wherein if the action is based on a value in the zone for acceptable values, a remaining operating time is estimated, displayed and transmitted.

16. The method of claim 4, wherein if the action is based on a value in the zone for nonacceptable values, an alarm and/or default is set, displayed, and/or transmitted.

17. The method of claim 1, wherein an operating time, T_{max_real}, for identification of the operational status of the device is determined by:
T_{max_real}=T_{max_worst}+A_{f}(T_{max_best}−T_{max_worst})
wherein:
A_{f} is an ageing factor,
T_{max_worst} is an operating time value in the first boundary values, and
T_{max_best} is an operating time value in the first boundary values.

18. The method of claim 1, comprising:
measuring by the device the first data,
calculating a time derivative, ΔP′, for the first data,
generating the action if the ΔP′ exceeds a threshold value before a maximum critical parameter value is reached.

19. The method of claim 1, wherein the second data depend on environment or operating conditions of the device and/or the part associated with the device.

20. The method of claim 1, wherein the action is one of or several of:
a signal for reconfiguring the device and/or the part associated with the device,
a prediction about operating time of the device and/or the part associated with the device, or
an advice at least comprising a notification to a user and/or helpdesk for the device and/or the part associated with the device.

21. The method of claim 5, wherein the computer implemented method further comprises:
obtaining a printer identity;
obtaining printer running data and/or an operational parameter;
setting a control run parameter;
defining a run-time for running a control based on the control run parameter,
running a control operation based on the defined run-time,
processing printer running data and/or the operational parameter,
comparing result of the processing with previous or determined outcomes of printer operation, and
based on a result of the comparison generating the action.

22. The method of claim 21, wherein the action comprises one or several of handling operational parameters for avoiding fault's bases on printer running data and on the operational parameter.

23. The method of claim 1, wherein the computer and/or the data storage is part of the device.

24. The method of claim 1, wherein the computer is part of a cloud computing node or edge computing node.

25. The method according to claim 24, wherein the data storage is part of a cloud computing node.

26. The method according to claim 20, the action further comprises one or several of replacing a part, stopping the device's operation in a specific time, prediction of remaining lifetime and measures thereof, or take manual or automatic measures to avoid stops or delays in the production.

27. The method of claim 1, for prediction of clogging of a filter in an ink jet circuit of an ink jet printer, the method comprising:
generating a flow in a first ink flow circuit to set an ink pressure,
measuring by an ink pressure sensor the generated ink flow,
keeping the ink pressure by means of motor speed of an ink pump,
setting a second operating point by keeping the pump motor speed and generating a flow for the ink in a second ink flow circuit via an ink filter;
measuring the ink pressure depending on a ink filter pressure change;
receiving the current critical parameter values comprising the pressure value from the pressure sensor; and
providing the current critical parameters to the computer for analyzing the pressure data.

28. The method of claim 27, further comprising:
comparing the current critical parameters with stored values:
if the ink filter is clogged, the current critical parameter for pressure from the pressure sensor is lower than a set pressure;
if the ink filter is not clogged, the pressure read by the ink pressure sensor is higher than set pressure.

29. A computer comprising:
a processing unit,
a memory, and
a communication interface configured to process at least one critical parameter value and/or setting for a device over a time period, and to identify an operational status of the device,
the processing unit being configured to:
monitor a first data during the operation of the device, the first data representing at least one current critical parameter value for the device from a first data source and a second data representing worst and best values representing boundaries for the functionality of the device,
analyse the first data and the second data by comparing said first and second data, and
generate an action about the operation of the device or an arrangement associated with the device based on the result of the comparison.

30. A system comprising:
at least one printer;
a database;
a computer comprising: a processing unit, a memory and a communication interface configured to process a critical parameter value and/or setting for the printer or a part associated with the printer over a time period, and to identify an operational status of the printer or the part associated with the printer, the processing unit being configured to:
monitor, during the operation of the at least one printer, a first data representing at least one current critical parameter value for the at least one printer or the part from a first data source and a second data representing worst and best values representing boundaries for functionality of the at least one printer,
analyse the first data for the at least one printer or the part and the second data by comparing the first and second data; and
generate an action for operation of the at least one printer or the part associated with the at least one printer based on the result of the comparison.

31. The system of claim 30, wherein the computer is arranged at least in:
communication with the at least one printer;
the at least one printer;
an edge computing node; or
a cloud computing node.

32. The system of claim 30, wherein the critical parameter values are obtained from one or several of optical/magnetic encoder or sensors for: temperature, pressure, level, humidity, air bubble detection, position, distance, laser thru-beam, vision, consumable, ink jet position, slightly deviated ink jet, ink jet presence, ink jet speed, recovery/gutter overflow, head dirtiness, phase, covers/parts presence, accelerometer, vibrations, printhead position, or break-off point.

33. The system according to claim 30, wherein the first data source comprises a data providing unit comprising one or several external ambient sensors, including: humidity, temperature, air quality, proximity, altitude, pressure, VOC (Volatile organic compounds), or CO/O₂/CO₂.

34. A computer implemented method, executed by a processing unit of a computer, to process at least one operation critical parameter value and/or settings for a device over a time period, for identification of an operational status of the device, the method comprising:
obtaining a first data representing at least one current critical parameter value for the device from a first data source and a second data representing at least one reference critical parameter value and/or correction value and/or setting associated with the device from a data storage,
analysing the first data for the device and the second data with the device, whilst also acquiring, aggregating and/or analysing a third data representing at least any further necessary critical parameter value associated with the device from a first and/or two or more further sources,
processing the first, second and third data with respect to the operating time of the device, wherein the processing is an artificial intelligence or machine learning process comprising the steps of:
training a model using the first data with respect to an operational lifetime of the device,
predict with the trained model, by input to the model parameter data, and
generate the action;
wherein an operation time, T_{max_real}, for identification of the operational status of the device is determined by:
T_{max_real}=T_{max_worst}+A_{f}(T_{max_best}−T_{max_worst})
wherein:
A_{f} is an ageing factor,
T_{max_worst} is an operating time value in the first boundary values, and
T_{max_best} is an operating time value in the first boundary values,
and generating an action for operation of the device or an arrangement associated with the device.

34. The system of claim 30, wherein the system is configured to check that the parameters meet nominal values and if out of bounds may stop printing or alert a user to stop printing, after that the critical parameters are acquired.

35. The system of claim 30, wherein the critical parameters include a jet speed parameter, an ink level is too low, or a voltage current consumption is too high.
